(19) United States
(12) Patent Application Publication
(10) Pub. No.: US 2023/0057470 A1
(43) Pub. Date: Feb. 23, 2023

(54) HIGH RESOLUTION MULTI-FIELD-OF-VIEW IMAGING SYSTEM

(71) Applicant: Onto Innovation Inc., Wilmington, MA (US)

(72) Inventors: John A. Tejada, Londonderry, NH (US); Ju Jin, Edina, MN (US); Jian Ding, Methuen, MA (US)

(21) Appl. No.: 17/820,474

(22) Filed: Aug. 17, 2022

Related U.S. Application Data
(60) Provisional application No. 63/260,384, filed on Aug. 18, 2021.

(51) Int. Cl. G02B 13/22; G02B 21/02; G02F 1/33; G02B 21/36; H04N 5/232; G02B 25/00; G02B 21/24

(52) U.S. Cl. CPC G02B 13/22; G02B 21/02; G02F 1/33; G02B 21/365; H04N 5/23235; H04N 5/23212; G02B 25/001; G02B 21/244

(57) ABSTRACT

A multichannel tunable lens system may include a review channel with a fluidic focusing device, which can adjust the focus of the channel rapidly to mitigate environmental vibrations. The review channel may generate high resolution images with reduced blur caused by vibrations or air turbulence while increasing the operating speed of the system. The review channel may include a telescope objective and eyepiece with telecentricity to generate a real image of the pupil in the fluidic focusing device. The system may also include an inspection channel to generate lower resolution images in parallel and a focus channel to determine contour information.

### CROSS-REFERENCE TO RELATED APPLICATION

This application claims the benefit of priority to U.S. Provisional Patent Application Ser. No. 63/260,384 filed Aug. 18, 2021, the contents of which are incorporated herein by reference in its entirety.

### TECHNICAL FIELD

The present disclosure generally relates to imaging systems, in particular high resolution optical systems used for inspection applications.

### BACKGROUND

One of the more demanding inspection applications is wafer inspection of two-dimensional (length and width) features created during a deposition process. The inspection can be further complicated by correlating those features with other features at different heights to quantify and correlate defects and their locations. Some defects may be too small for a low-resolution system to detect.

Some high-resolution systems however can also suffer from significant drawbacks. For example, images in some high-resolution systems can be more susceptible to defocusing and/or image degradation caused by external and internal vibration sources because those systems can employ piezoelectric transducers (PZT) to generate the focus steps to provide incremental motion yielding the desired image resolution. The movement of the PZTs can cause optical aberrations, reducing image quality and system resolution. Additionally, PZT motion can have a settling time for the system to settle before focusing after movement, which can slow down the measurement cycle.

### SUMMARY

A multichannel tunable lens system may include a review channel with a fluidic focusing device, which can adjust the focus of the channel rapidly to mitigate environmental vibrations. The review channel may generate high resolution images with reduced blur caused by vibrations or air turbulence while increasing the operating speed of the system. The review channel may include a telescope objective and eyepiece with telecentricity to generate a real image of the pupil in the fluidic focusing device. The system may also include an inspection channel to generate lower resolution images in parallel and a focus channel to determine contour information.

This disclosure describes a tunable lens system for substrate inspection. The tunable lens system may include a microscope objective positioned opposite a substrate to magnify the substrate. The tunable lens system may also include a review channel, comprising: a telescope objective including at least two lens components to generate a telecentric intermediate image; an eyepiece including at least two lens components to recollimate the telecentric intermediate image; a fluidic focusing device with a variable focus shift based on a variable index of refraction, the fluidic focusing device to focus the review channel to a set focus position; and an imager to generate a review image of the substrate.

This disclosure also describes a method for assisting inspection of a substrate, the method comprising: positioning the substrate opposite a microscope objective; generating a telecentric intermediate image using at least two lens components of a telescope objective; recollimating the telecentric intermediate image using at least two lens components of an eyepiece; adjusting a focus level of a fluidic focusing device based on an applied charge; and generating a review image of the substrate.

This disclosure further describes a multi-channel lens system. The multi-channel lens system may include a microscope objective positioned opposite a substrate, an energy beamsplitter to split beams generated by the microscope objective into a first set of energy beams and a second set of energy beams, and an inspection channel to receive the first set of energy beams and to generate an inspection image of the substrate. A spectrum beamsplitter can split the second set of energy beams into a first set of spectrum beams and a second set of spectrum beams. A review channel can receive the first set of spectrum beams and to generate a review image of the substrate. The review channel may include a telescope objective to generate a telecentric intermediate image, an eyepiece to recollimate the telecentric intermediate image, a fluidic focusing device with a variable focus shift based on a variable index of refraction, the fluidic focusing device to focus the review channel to a set focus position, and an imager to generate the review image

### BRIEF DESCRIPTION OF THE DRAWINGS

Various ones of the appended drawings merely illustrate example embodiments of the present disclosure and should not be considered as limiting its scope.

FIG. 1 illustrates example portions of a tunable lens system.

FIG. 2 illustrates example portions of a review channel.

FIG. 3 illustrates example portions of an inspection channel.

FIG. 4 illustrates example portions of a focus channel.

FIG. 5 illustrates a flow diagram for a method for generating review and inspection images.

### DETAILED DESCRIPTION

A multichannel tunable lens system that addresses the aforementioned problems is disclosed. The system may include a review channel with a fluidic focusing device, which can adjust the focus of the channel rapidly so as to mitigate environmental vibrations. The review channel may generate high resolution images with reduced blur caused by vibrations while increasing the operating speed of the system. The review channel may include a telescope objective and eyepiece with telecentricity to generate a real image of the pupil in the fluidic focusing device. The system may also include an inspection channel to generate lower resolution images in parallel and a focus channel to determine contour information.

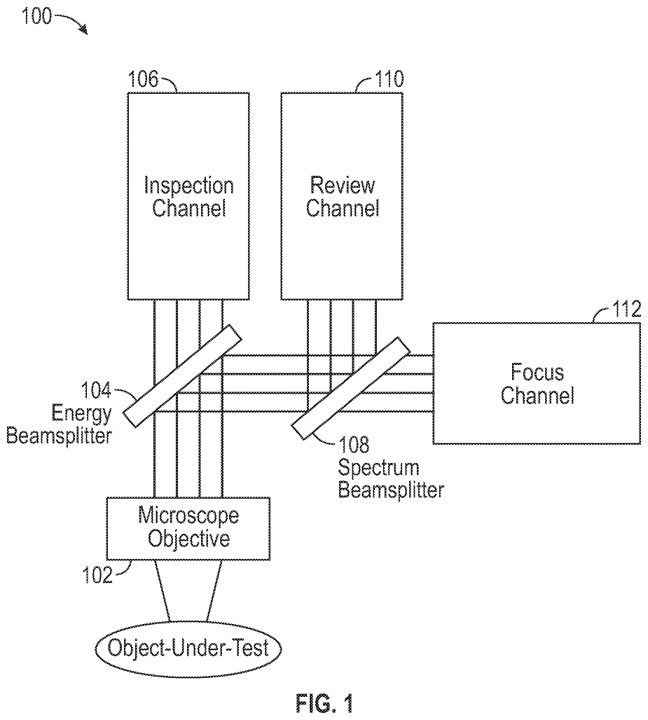

FIG. 1 illustrates example portions of a tunable lens system 100. The tunable lens system 100 may include a microscope objective 102, an energy beamsplitter 104, an inspection channel 106, a spectrum beamsplitter 108, a review channel 110, and a focus channel 112. In operation, an object-under-test (e.g., semiconductor wafer, device, etc.) may be placed under the microscope objective 102.

The tunable lens system 100 may include three channels: the inspection channel 106, the review channel 110, and the focus channel 112. These channels may operate concurrently. The inspection channel 106 may generate a lower resolution image of the object-under-test as compared to the review channel 110, which generates a higher resolution image of the object-under-test. The focus channel 112 may be used to adjust the focus of the inspection channel 106.

The microscope objective 102 may include optical lenses and other optical components to provide a fixed magnification. The microscope objective 102 may be selectable from a plurality of objectives to achieve different magnifications.

The energy beamsplitter 104 may be provided as an optical component, such as a plate, to split the incident light from the microscope objective 102 into two sets of separate beams. One set of beams from the energy beamsplitter 104 may propagate into the inspection channel 106.

The inspection channel 106 may include lenses and other optical components to magnify and focus the beams and a detector to form the lower resolution image, i.e., inspection image. Examples of the inspection channel 106 are described in further detail below.

The other set of beams from the energy beamsplitter 104 may reach the spectrum beamsplitter 108. The spectrum beamsplitter 108 may be provided as a dichroic beamsplitter. The spectrum beamsplitter 108 may include optical components, such as a plate, to split the set of beams from the energy beamsplitter 104 into two sets of spectrums. A first spectrum set may propagate into the review channel 110, and a second spectrum may propagate into the focus channel 112. In some examples, the first spectrum set may include visible wavelengths and the second spectrum set may include near-infrared wavelengths. In these examples, the visible spectrum beams may propagate into the review channel 110, and the near-infrared spectrum beams may propagate into the focus channel 112.

The focus channel 112 may include a focus sensor to assist in determining the contour of the object-under-test (e.g., substrate, wafer). Based on the information gathered by the focus channel 112 (e.g., contour information of the object-under-test), the focus of the inspection channel 106 may be adjusted. For example, the focus of an inspection lens in the inspection channel 106 may be adjusted accordingly, as described in further detail below.

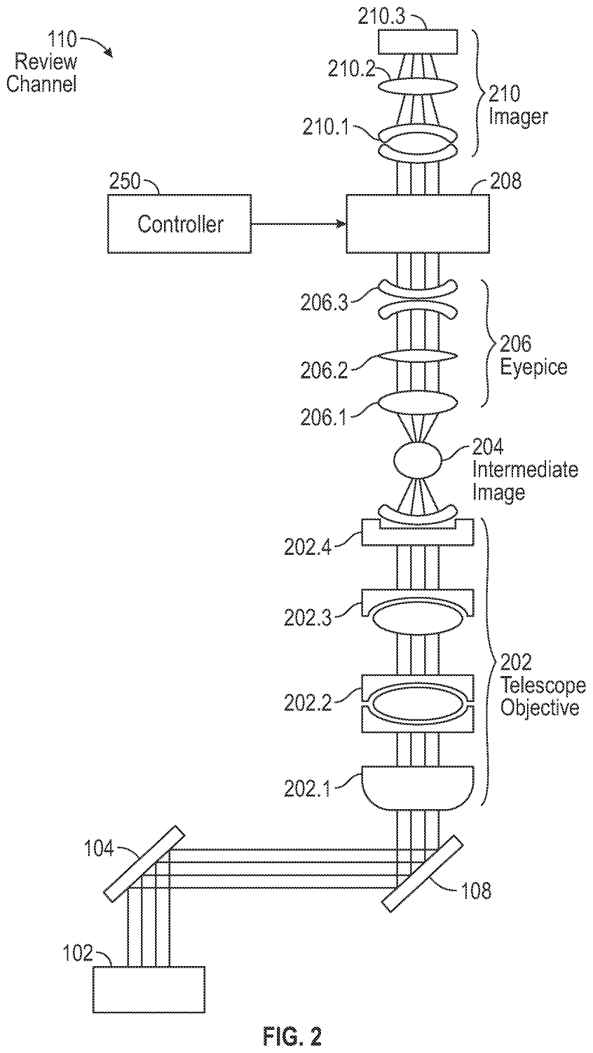

The review channel 110 may include lenses and optical components, including a fluidic focusing device, to focus the visible spectrum beams and a detector to form the higher resolution image, i.e., review image. FIG. 2 illustrates example portions of the review channel 110. The review channel 110 may include a telescope objective 202, an eyepiece module 206, a fluidic focusing device 208, an imager 210, and a controller 250.

The first set of spectrum beams (e.g., visible spectrum beams) from the spectrum beamsplitter 108 may propagate through the telescope objective 202. The telescope objective 202 may focus collimated light generated by the microscope objective 102 to create an intermediate image 204. The intermediate image 204 may be a real, focused image that forms a real pupil (e.g., an image of the aperture stop located at the back of the telescope objective 202). The intermediate image 204 may be a telecentric image. For example, the telecentric image may have all chief rays substantially parallel to an optical axis. The telescope objective 202 may include a plurality of lens components to create the telecentric intermediate image and to correct color and image aberrations in the visible spectrum. The lens components may be provided as spherical lenses of glass substrates. For example, the telescope objective 202 may include four lens components 202.1-202.4. In this example, lens component 202.1 may be provided as a singlet lens; lens component 202.2 may be provided as a triplet lens; and lens components 202.3, 202.4 may be provided as doublet lenses.

The eyepiece module 206 may take the telecentric intermediate image and make it recollimated (e.g., make the rays parallel again). The eyepiece module 206 may form a real image of the pupil in the fluidic focusing device 208. The real image formed in the fluidic focusing device 208 may be afocal. The telescope objective 202 and the eyepiece module 206 may form a Newtonian afocal. The eyepiece module 206 may include a plurality of lens components. The lens components may be provided as spherical lenses of glass substrates. For example, the eyepiece module 206 may include three lens components 206.1-206.3. In this example, lens components 206.1, 206.2 may be provided as singlet lenses, and lens component 206.3 may be provided as a doublet lens. The combination of the telescope objective 202 and the eyepiece module may provide an afocal magnification, such as 2.5×.

The fluidic focusing device 208 may include a variable focus shift based on the variable index of refraction of the fluid encapsulated therein. That is, a charge may be applied by the controller 250 to the fluidic focusing device 208 to change the index of refraction of the fluid in the fluidic focusing device 208, which in turn adjusts the focus of the review channel 110. The charge may be an electric or magnetic charge. The fluidic focusing device 208 may receive the recollimated image from the eyepiece module 206 and may add power to the image, enabling the focus to change when the final image reaches the imager 210. The controller 250 may adjust the charge applied to the fluidic focusing device 208 to rapidly change the focus of the final image, thus accounting for different contour variations of the object-under-test. For example, the fluidic focusing device 208 may be provided as a tunable acoustic gradient lens.

The imager 210 may include a focusing lens 210.1, an imager lens 210.2, and a detector 210.3. The focusing 210.1 and the imager lens 210.2 may focus the image on the detector 210.3, which may be provided as an image sensor with an array of pixel components used to create the final image of the review channel (e.g., CMOS image sensor, camera, etc.). In an example, the focusing lens 210.1 may be provided as a doublet lets component. The final review image generated by the review channel 110 may have a higher resolution and may not be substantially degraded by environmental vibrations. For example, environmental vibrations can come from a granite base on which the lens system is placed, from the floor, or from other places.

Systems with mechanical devices (e.g., PZT) to change the focus of the review channel may not be able to mitigate the adverse effects of these environmental vibrations because the image capture rate is typically slower than the environmental vibrations. Thus, the floor vibrations could cause blurring of the image. In contrast, the review channel, as described herein, can focus much faster (i.e., faster focusing time) and thus can reduce or even eliminate the adverse effects of environmental vibrations.

Moreover, the object-under-test and review image may be telecentric, as described herein. Providing this telecentricity offers advantages of being able to move the image to adjust the focus (e.g., by fluidic focusing device 208) without changing the height of the detector. Thus, a variable power lens (e.g., fluidic focusing device 208) can introduce power without transversely displacing the image on the detector.

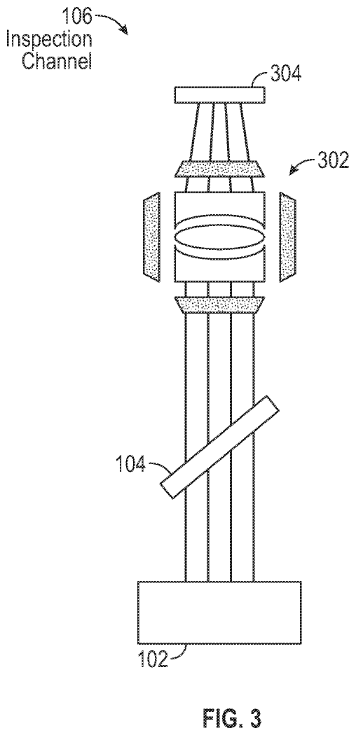

FIG. 3 illustrates example portions of the inspection channel 106. The inspection channel 106 may include a tube lens module 302 and an inspection detector 304. The split energy beams from the energy beamsplitter 104 may propagate through the tube lens module 302. The tube lens module 302 may include adjustable lens components, e.g., four lens components. In one example, the focus of the tube lens module 302 may be adjusted by one or more piezoelectric transducers (PZT). The tube lens module 302 may the focus the beams on the inspection detector 304, which may be provided as an image sensor with an array of pixel components used to create the final image of the inspection channel (e.g., CMOS image sensor, camera, etc.). The final inspection image may have a lower resolution as compared to the final review image.

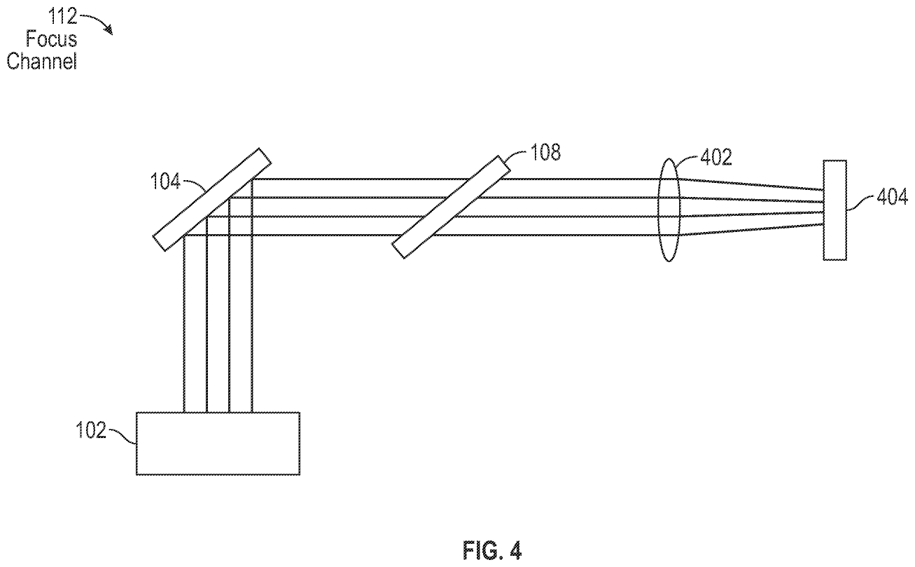

FIG. 4 illustrates example portions of the focus channel 112. The focus channel 112 may include a focus lens 402 and a focus sensor 404. The second set of spectrum beams (e.g., near-infrared spectrum beams) from the spectrum beamsplitter 108 may propagate through the focus lens 402. The focus lens 402 may focus the beams on the focus sensor 404. For example, the focus lens 402 may be provided as a near-infrared sensor for near-infrared spectrum beams. The focus sensor 404 may determine the contour of the object-under-test. The output of the focus sensor 404 may then be used to adjust the focus of the inspection channel 106. For example, the output of the focus sensor 404 may be used to adjust the PZT to adjust the focus of the tube lens module 302 described above.

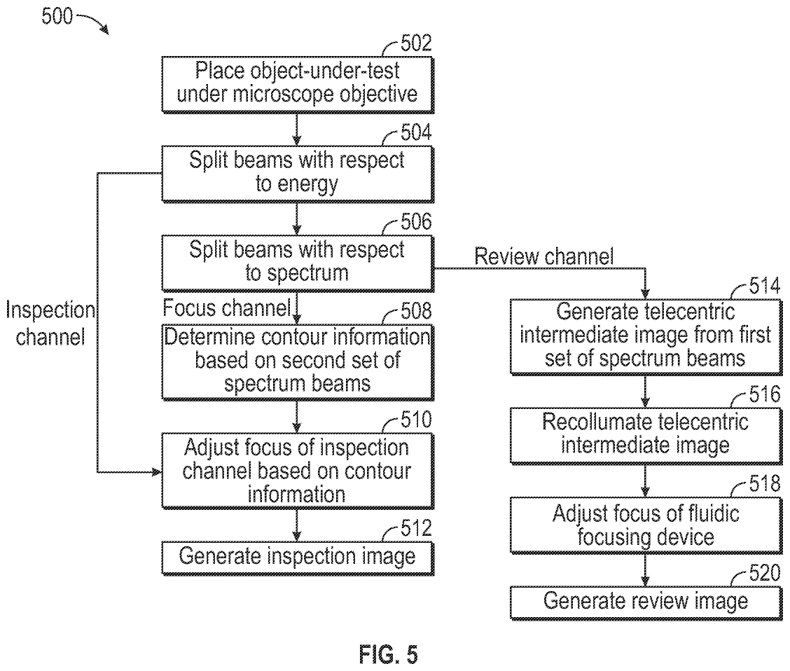

FIG. 5 is a flow diagram of a method 500 to generate review and inspection images. For example, method 500 may be executed by the tunable lens system 100 described herein. At step 502, an object-under-test (e.g., substrate, wafer, etc.) may be placed under a microscope objective. At step 504, the beams generated by the microscope objective representing the object-under-test may be split with respect to energy.

At step 506, one set of the energy beams may further split with respect to spectrum into two spectrum sets. For example, a first spectrum set may include visible wavelengths and a second spectrum set may include near infrared wavelengths. Other spectrums may also be used. The second set of spectrum beams (e.g., near-infrared spectrum beams) may then propagate through a focus channel. At step 508, information regarding the contour of the of object-under-test may be determined based on the second set of spectrum beams.

Returning to the output of the step 504, the other set of energy beams may propagate through an inspection channel. At step 510, the focus of the inspection channel may be adjusted based on the contour information determined in step 508 (i.e., in focus channel). At step 512, an inspection image of the object-under-test may be generated.

Returning to the output of step 506, the first set of spectrum beams (e.g., visible spectrum beams) may propagate through a review channel. At step 514, a telecentric intermediate image from the first set of spectrum beams. At step 516, the telecentric intermediate image may be recollimated, forming a real image in a fluidic focusing device. At step 518, focus of the fluidic focusing device may be adjusted by changing the index of refraction of the fluid in the fluidic focusing device. At step 520, a review image of the object-under-test may be generated. The review image may have a higher resolution than the inspection image and may have a faster focusing time. The inspection image and review image may be generated in parallel (e.g., substantially simultaneously).

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific implementations in which the invention can be practiced. These implementations are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a aspects are still deemed to fall within the scope of that aspect. Moreover, in the following aspects, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure.

1. A tunable lens system for substrate inspection, the tunable lens system comprising:
a microscope objective positioned opposite a substrate to magnify the substrate; and
a review channel, comprising:
a telescope objective including at least two lens components to generate a telecentric intermediate image;
an eyepiece including at least two lens components to recollimate the telecentric intermediate image;
a fluidic focusing device with a variable focus shift based on a variable index of refraction, the fluidic focusing device to focus the review channel to a set focus position; and
an imager to generate a review image of the substrate.

2. The tunable lens system of claim 1, further comprising:
an inspection channel including a tube lens module and a detector to generate an inspection image.

3. The tunable lens system of claim 2 wherein the review image and the inspection image are generated in parallel and the review image has a higher resolution than the inspection image.

4. The tunable lens system of claim 1, further comprising:
a focus channel to determine contour information of the substrate.

5. The tunable lens system of claim 4, wherein the contour information is used to adjust a focus of an inspection channel.

6. The tunable lens system of claim 1, wherein the telescope objective includes four spherical lens components for telecentric imaging.

7. The tunable lens system of claim 6, wherein the four spherical lens components include a singlet lens, a triplet lens, and two doublet lenses.

8. The tunable lens system of claim 1, wherein the eyepiece includes four lens components including two singlet lenses and one doublet lens.

9. The tunable lens system of claim 1, wherein the fluidic focusing device includes a tunable acoustic gradient lens.

10. A method for assisting inspection of a substrate, the method comprising:
positioning the substrate opposite a microscope objective;
generating a telecentric intermediate image using at least two lens components of a telescope objective;
recollimating the telecentric intermediate image using at least two lens components of an eyepiece;
adjusting a focus level of a fluidic focusing device based on an applied charge; and
generating a review image of the substrate.

11. The method of claim 10, further comprising:
generating an inspection image of the substrate substantially simultaneously to the review image, wherein the review image has a higher resolution than the inspection image.

12. The method of claim 11, further comprising:
determining contour information of the substrate based on a near infrared spectrum; and
adjusting a focus level of the inspection image based on the contour information.

13. The method of claim 10, wherein the telescope objective includes four spherical lens components for telecentric imaging.

14. The method of claim 13, wherein the four spherical lens components include a singlet lens, a triplet lens, and two doublet lenses.

15. The method of claim 10, wherein the eyepiece includes three lens components including two singlet lenses and one doublet lens.

16. The method of claim 10, wherein the fluidic focusing device includes a tunable acoustic gradient lens.

17. A multi-channel lens system, comprising:
a microscope objective positioned opposite a substrate;
an energy beamsplitter to split beams generated by the microscope objective into a first set of energy beams and a second set of energy beams;
an inspection channel to receive the first set of energy beams and to generate an inspection image of the substrate;
a spectrum beamsplitter to split the second set of energy beams into a first set of spectrum beams and a second set of spectrum beams; and
a review channel to receive the first set of spectrum beams and to generate a review image of the substrate, the review channel comprising:
a telescope objective to generate a telecentric intermediate image,
an eyepiece to recollimate the telecentric intermediate image,
a fluidic focusing device with a variable focus shift based on a variable index of refraction, the fluidic focusing device to focus the review channel to a set focus position, and
an imager to generate the review image.

18. The multi-channel lens system of claim 17, further comprising:
a focus channel to determine contour information of the substrate, wherein the contour information is used to adjust a focus of the inspection channel.

19. The multi-channel lens system of claim 17, the telescope objective includes four spherical lens components for telecentric imaging.

20. The multi-channel lens system of claim 19, wherein the four spherical lens components include a singlet lens, a triplet lens, and two doublet lenses.
